(19) United States
(12) Patent Application Publication
(10) Pub. No.: US 2019/0142214 A1
(43) Pub. Date: May 16, 2019

(54) PAN

(71) Applicant: MICHAEL HOROVITZ, BROOKLYN, NY (US)

(72) Inventor: MICHAEL HOROVITZ, BROOKLYN, NY (US)

(21) Appl. No.: 15/814,483

(22) Filed: Nov. 16, 2017

(51) Int. Cl. A47J 36/16; A47J 37/10

(52) U.S. Cl. CPC A47J 36/165; B01F 15/00538; A47J 37/101; A47J 37/108

(57) ABSTRACT

A pan, including: a first cogwheel, being annular for surrounding the container of the pan, and for being rotational in relation to the container; a motor, for rotating the first cogwheel; and a stirring element extending from the first cogwheel into the container, thereby the stirring element stirs the contents of the container.

### TECHNICAL FIELD

The invention relates to the field of pans. More particularly, the invention relates to a pan allowing stirring the content thereof.

### BACKGROUND

There is a long felt need to provide a pan, allowing steering the content thereof.

### SUMMARY

A pan, including an annular rotational cogwheel; a motor; and a stirring element extending from the cogwheel into the container.

### BRIEF DESCRIPTION OF THE DRAWINGS

Embodiments, features, and aspects of the invention are described herein in conjunction with the following drawings:

FIG. 1 is a perspective top view of a pan according to one embodiment of the invention.

FIG. 2 is a perspective top view of a mechanism, for applying the stirring element of FIG. 1.

FIG. 3 is a perspective top view of the mechanism of FIG. 2, at a different rotational state.

FIG. 4 is similar to FIG. 1, except for an additional mechanism.

FIG. 5 is a magnified top view of FIG. 4 without the round cover of FIG. 4.

FIG. 6 is the top view of FIG. 5, except that the cogwheel of FIG. 2 is moved in relation to FIG. 5.

FIG. 7 is a perspective bottom view of FIG. 5 or of FIG. 6, except for omitting the stationary cogwheel and other elements.

FIG. 8 is similar to FIG. 7, at a different state, and adding the stirring element of FIG.

The drawings are not necessarily drawn to scale.

### DETAILED DESCRIPTION

The invention will be understood from the following detailed description of embodiments of the invention, which are meant to be descriptive and not limiting. For the sake of brevity, some well-known features are not described in detail.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

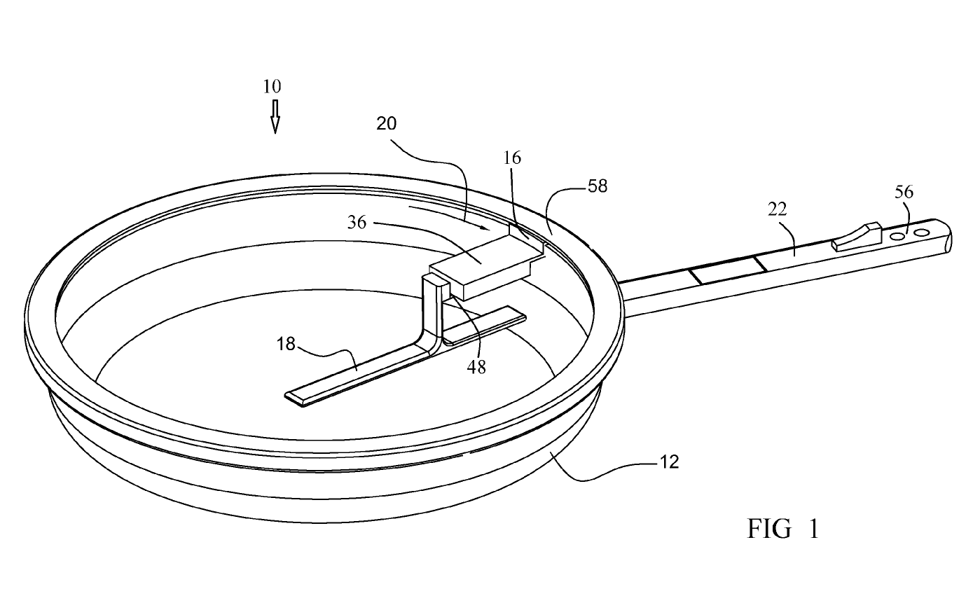

FIG. 1 is a perspective top view of a pan according to one embodiment of the invention.

A pan 10 according to one embodiment of the invention includes a stirring element 18, for stirring the content of the container 12.

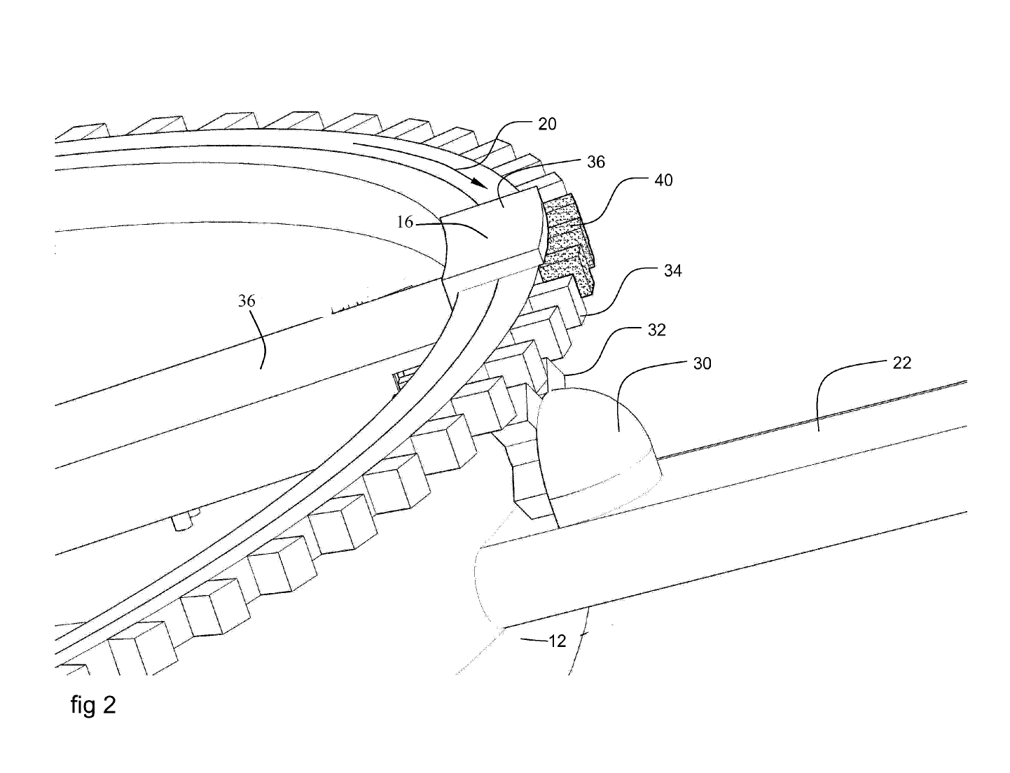

FIG. 2 is a perspective top view of a mechanism, for applying the stirring element of FIG. 1.

A motor 30, being supported by the pan's handle 22, rotates a cogwheel 32, being interlaced to an annular cogwheel 34, surrounding container 12, thus rotating annular cogwheel 34 in relation to container 12 and to handle 22, as shown by arrow 20.

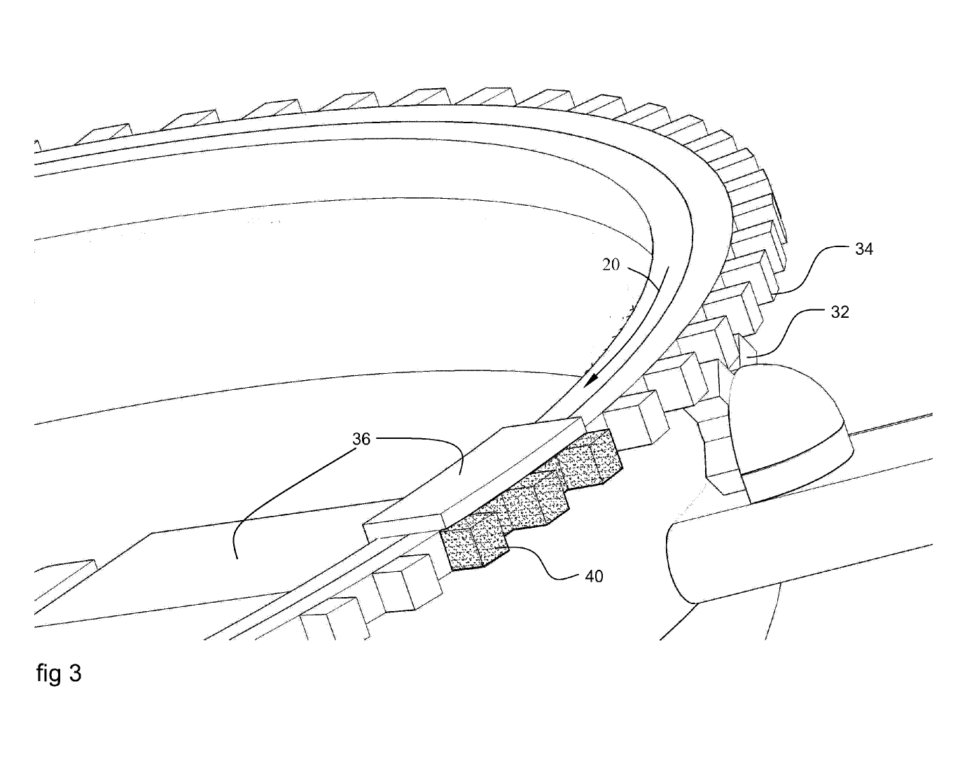

FIG. 3 is a perspective top view of the mechanism of FIG. 2, at a different rotational state.

For example, in FIG. 2, cog 40 of annular rotational cogwheel 34 is disposed right to cogwheel 32, whereas in FIG. 3, cog 40 is disposed left to cogwheel 32.

Referring again to FIG. 1, annular rotational cogwheel 34 of FIG. 2 is covered by a round cover 58.

Stirring element 18 is connected, through a stirring base 36, to annular rotational cogwheel 34, thus rotation of cogwheel 32 in relation to container 12 and to handle 22, rotates stirring base 36 and stirring element 18 in relation to container 12 and to handle 22, as shown by arrow 20.

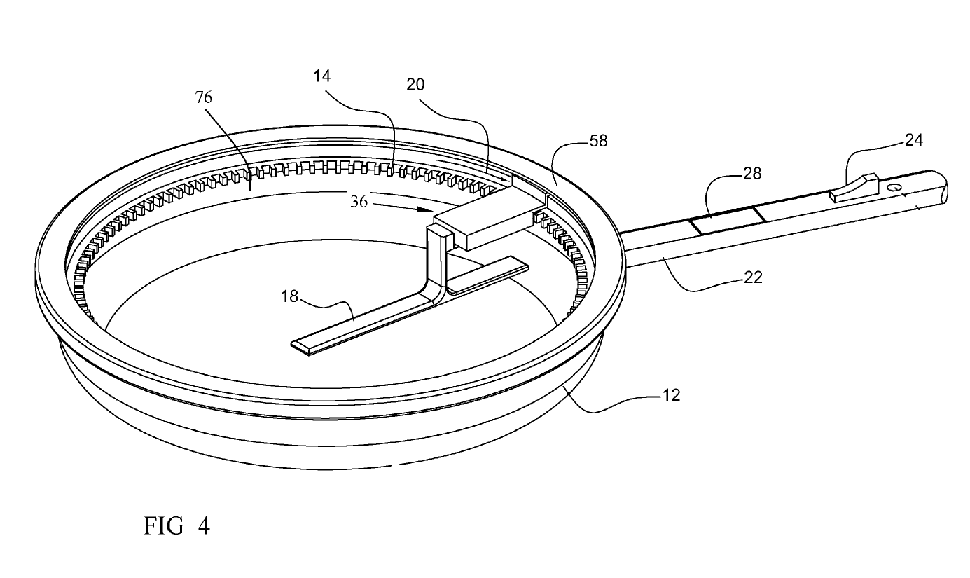

FIG. 4 is similar to FIG. 1, except for an additional mechanism.

According to the embodiment of FIG. 4, an additional annular cogwheel 14 is fixed to the internal wall 76 of container 12, thus being stationary in relation thereto.

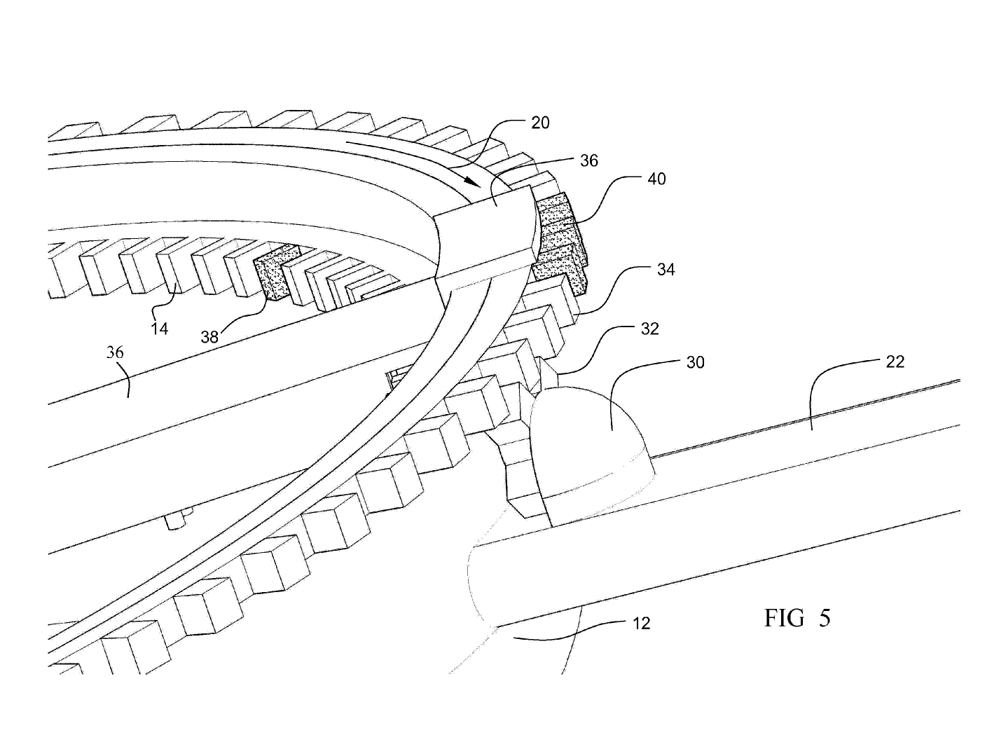

FIG. 5 is a magnified top view of FIG. 4 without the round cover of FIG. 4.

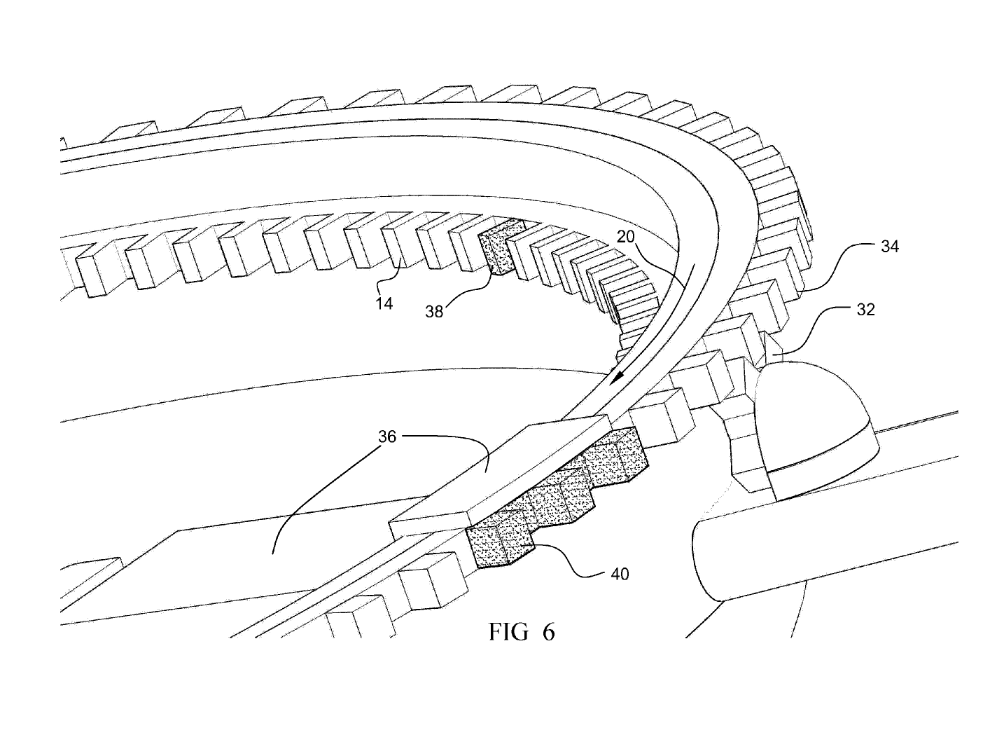

FIG. 6 is the top view of FIG. 5, except that the cogwheel of FIG. 2 is moved in relation to FIG. 5.

Since annular rotational cogwheel 34 is rotational in relation to container 12, and stationary annular cogwheel 14 is fixed to container 12, thus cogwheel 34 is rotational in relation to stationary annular cogwheel 14.

Thus, cog 38 is shown stationary in relation to handle 22 both in FIG. 5 and FIG. 6. In contrast, cog 40 of stationary annular cogwheel 14 is shown against handle 22 in FIG. 5, and is shown moved from handle 22 in FIG. 6.

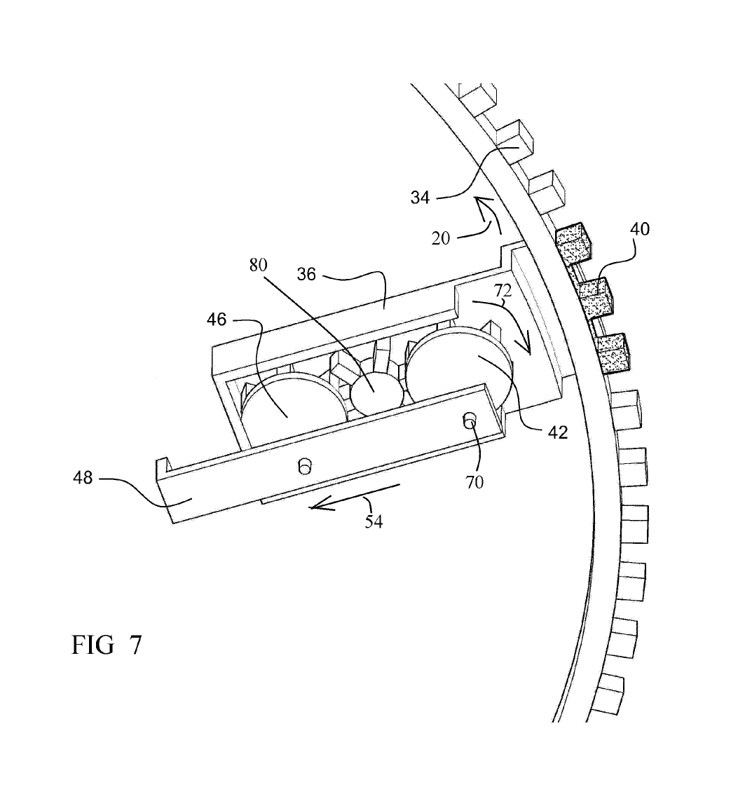

FIG. 7 is a perspective bottom view of FIG. 5 or of FIG. 6, except for omitting the stationary cogwheel and other elements.

Stationary annular cogwheel 14 (shown in FIG. 5, not shown in FIG. 7) is interlaced with a cogwheel 42, disposed within stirring base 36.

A hinge 70 of an arm 48 is pivotally connected eccentrically to cogwheel 42, for converting rotation of cogwheel 42 to linear motion of arm 48.

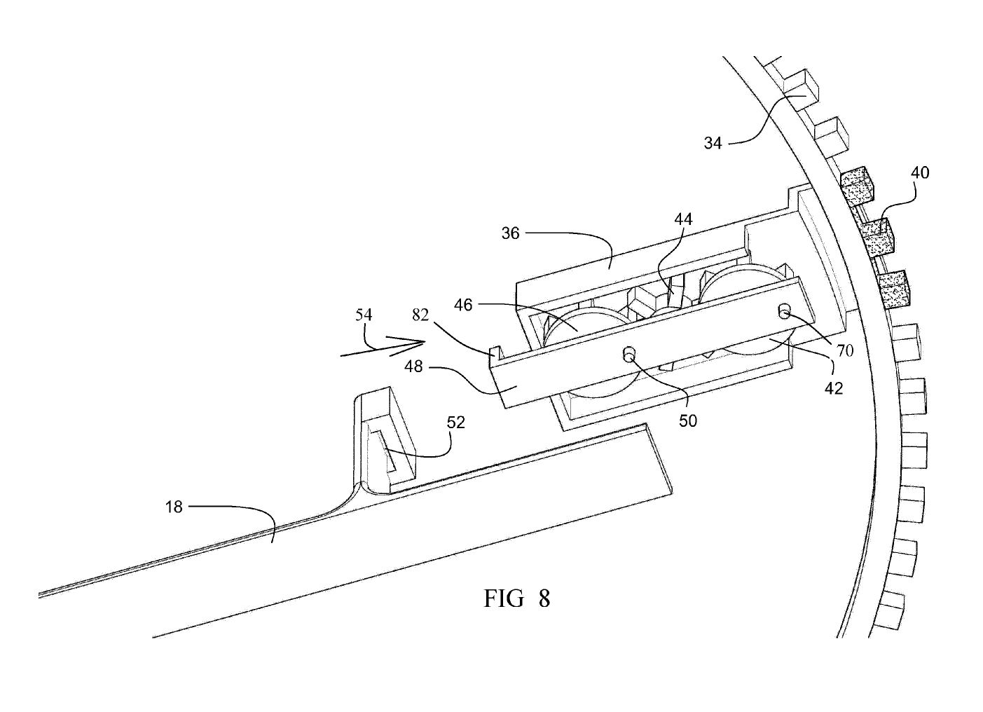

FIG. 8 is similar to FIG. 7, at a different state, and adding the stirring element of FIG. 1.

Thus, rotation of stirring base 36 and stirring element 18, as shown by arrow 20, rotates cogwheel 42, as shown by arrow 72; and rotation of cogwheel 42 moves arm 48 linearly back and forth, as shown by arrow 54, between the states of FIG. 7 and FIG. 8.

Arm 48 is connected to stirring element 18. Thus, rotation of stirring element 18, as shown by arrow 20, further moves stirring element 18 linearly back and forth.

Thus, in one aspect, the invention is directed to a pan (10), including:
a first cogwheel (34), being annular for surrounding the container (12) of the pan (10), and for being rotational in relation to the container (12);
a motor (30), for rotating the first cogwheel (34); and
a stirring element (18) extending from the first cogwheel (34) into the container (12),

thereby the stirring element (18) stirs the contents of the container (12).

The pan (10) may further include:
a second cogwheel (32), for being rotated by the motor (30), and for being interlaced with the first cogwheel (34).

The extension of the stirring element (18) from the first cogwheel (34) may be through a lump (36), functioning as a stirring base, and wherein the pan (10) further includes:
a third cogwheel (14), being annular and fixed to the internal wall (76) of the container (12); and
a fourth cogwheel (42) disposed on the lump (36) and being rotatable (72) in relation thereto, the fourth cogwheel (42) being interlaced with the third cogwheel (14), wherein the stirring element (18) is eccentrically connected to the fourth cogwheel (42), for converting the rotation (72) of the fourth cogwheel (42) to back and fourth linear motion (54) of the stirring element (18),

thereby the stirring of the stirring element (18) further includes the linear motion (54).

In FIG. 2, lump 16 is fixed above the wall of the pan, to cog 40, and as well to stirring base 36. Generally, the extension of the stirring element (18) from the first cogwheel (34) surrounding the container (12), into the container (12), preferably is through a lump (16), being disposed above the top of the wall of the container (12).

In the figures and/or description herein, the following reference numerals (Reference Signs List) have been mentioned:
numeral 10 denotes the pan according to one embodiment of the invention;
numeral 12 denotes the container of the pan;
numeral 14 denotes the stationary annular cogwheel;
numeral 18 denotes the stirring element;
numeral 20 denotes the rotation of annular cogwheel 34 and the stirring element in relation to container 12;
numeral 22 denotes the handle of the pan;
numeral 28 denotes an electrical socket for charging the battery;
numeral 30 denotes the motor;
numeral 32 denotes the cogwheel extending from the motor;
numeral 34 denotes the annular cogwheel being rotational about the container;
numeral 36 denotes the base of the stirring element, which may have various shapes, and thus is regarded as a lump;
numeral 38 denotes a certain cog of the stationary annular cogwheel;
numeral 40 denotes a certain cog of the rotational cogwheel;
numeral 48 denotes an arm, from which the stirring element extends, and is dismantlable therefrom;
numeral 50 denotes a hinge of arm 48, being pivotally connected eccentrically to cogwheel 46;
numeral 52 denotes a fastening member of the stirring element to arm 48;
numeral 54 denotes the linear motion of arm 48;
numeral 58 denotes a cover for covering cogwheel 34;
numeral 70 denotes a hinge of arm 48, being pivotally connected eccentrically to cogwheel 42;
numeral 72 denotes rotation of cogwheel 42;
numeral 76 denotes the internal wall of the container;
numeral 78 denotes a battery cover;
numeral 80 denotes a cogwheel being interlaced with cogwheel 42;
numeral 82 denotes a fastening member of arm 48 to the stirring element;
numeral 46 denotes a cogwheel being interlaced with cogwheel 80;

The foregoing description and illustrations of the embodiments of the invention have been presented for the purpose of illustration, and are not intended to be exhaustive or to limit the invention to the above description in any form.

Any term that has been defined above and used in the claims, should to be interpreted according to this definition.

The reference numbers in the claims are not a part of the claims, but rather used for facilitating the reading thereof. These reference numbers should not be interpreted as limiting the claims in any form.

What is claimed is:

1. A pan, comprising:
a first cogwheel, being annular for surrounding a container of said pan, and for being rotational in relation to said container;
a motor, for rotating said first cogwheel; and
a stirring element extending from said first cogwheel into said container,
thereby said stirring element stirs contents of said container.

2. A pan according to claim 1, further comprising:
a second cogwheel, for being rotated by said motor, and for being interlaced with said first cogwheel.

3. A pan according to claim 1, wherein said extension of said stirring element from said first cogwheel is through a lump, and wherein said pan further comprises:
a third cogwheel, being annular and fixed to an internal wall of said container; and
a fourth cogwheel disposed on said lump and being rotatable in relation thereto, said fourth cogwheel being interlaced with said third cogwheel, wherein said stirring element is eccentrically connected to said fourth cogwheel, for converting said rotation of said fourth cogwheel to back and fourth linear motion of said stirring element,
thereby said stirring of said stirring element further comprises said linear motion.

4. A pan according to claim 1, wherein said extension of said stirring element from said first cogwheel surrounding said container, into said container, is through a lump, being disposed above a top of a wall of said container.
